(19) United States
(12) Patent Application Publication
(10) Pub. No.: US 2017/0024412 A1
(43) Pub. Date: Jan. 26, 2017

(54) GEO-EVENT PROCESSOR

(71) Applicant: Environmental Systems Research Institute (ESRI), Redlands, CA (US)

(72) Inventors: Cory MOLLENKOPF, Yucaipa, CA (US); Erik HOEL, Redlands, CA (US); Jay THEODORE, Redlands, CA (US)

(21) Appl. No.: 15/213,143

(22) Filed: Jul. 18, 2016

Related U.S. Application Data
(60) Provisional application No. 62/193,725, filed on Jul. 17, 2015.

(51) Int. Cl. G06F 17/30

(52) U.S. Cl. CPC G06F 17/30241; G06F 17/30336; G06F 17/30864; G06T 11/206

(57) ABSTRACT

Embodiments of the present invention provide a geoevent processor with the ability to enable real-time GIS (Geographic Information System). The geoevent processor has connectors that enable ingesting real-time data from a wide variety of sources. Those can include social media, in-vehicle GPS devices, military formats, and many more. Once connected, the geoevent processor provides the ability to perform continuous analysis and processing as the data is received. A spatiotemporal database is used to store real time observational data by location and time.

### RELATED APPLICATIONS

This application claims priority to provisional application No. 62/193,725 filed Jul. 17, 2015, the disclosure of which is incorporated herein by reference.

### BACKGROUND

The present invention relates to mapping applications. Mason Pub. No. 20110041088 describes real-time display of status and location information, such as for a fleet of tracked vehicles. A zoom feature displays individual assets at one level, and clusters of like assets at a zoomed-out level. Sharma US Pub. No. 20150332325 describes a map-based system and method allow an operator of a computer system to visualize real-time events of mobile users entering, staying within, and exiting geographic regions of interest. It uses a geo-fence database with spatial indices.

Wang Pub. No. 20140278055 describes an in-memory spatial index to quickly find the set of roads near a sample [par. 0041]. An in-memory spatial index is also described in Chithambaram Pub. No. 20040156326 [paragraphs 0095, 0137] for improved performance and scalability. Turgman Pub. No. 20140045516 describes determining when two moving geo-fences intersect [0023] for mobile phone users with matching interests.

### BRIEF SUMMARY

Embodiments of the invention relate to a geoevent processor with the ability to enable real-time GIS (Geographic Information System). The geoevent processor has connectors that enable ingesting real-time data from a wide variety of sources. Those can include social media, in-vehicle GPS devices, military formats, and many more. Once connected, the geoevent processor provides the ability to perform continuous analysis and processing as the data is received. A spatiotemporal database is used to store real time observational data by location and time.

### BRIEF DESCRIPTION OF THE DRAWINGS

FIG. 1 illustrates a simplified block diagram of an embodiment.

FIG. 2 illustrates a computer system 200 for performing semantic modeling of geographic information in business intelligence, according to certain embodiments of the invention.

FIG. 3 depicts a simplified diagram of a distributed system 300 for providing a system and method for performing semantic modeling of geographic information in business intelligence, according to an embodiment of the invention.

### DETAILED DESCRIPTION

Embodiments of the present invention provide a geoevent processor with the ability to enable real-time GIS (Geographic Information System). The geoevent processor has connectors that enable ingesting real-time data from a wide variety of sources. Those can include social media, in-vehicle GPS devices, military formats, and many more. Once connected, the geoevent processor provides the ability to perform continuous analysis and processing as the data is received. A spatiotemporal database is used to store real time observational data by location and time.

In one embodiment, high velocity and volume are provided. GIS is used to analyze real-time geospace data, integrate real-time streaming data into ArcGIS, perform continuous processing and real-time analytics, and send updates and alerts to those who need it where they need it. Real-time analytics are performed by defining a GeoEvent Service. This GeoEvent Service will configure the flow of GeoEvents by filtering and GeoEvent Processing the steps to perform, that inputs to apply them to, and what outputs to send the results to. One can perform continuous analytics on GeoEvents as they are received using a processor. Users will be able to create their own processors. One can easily disseminate notifications, alerts, and updates by using an Output Connector. Users will be able to create their own connectors.

There are two patterns for getting Real-Time data into Web Applications. The first being feature layers pulling from feature services. In this first feature, web apps poll to get periodic updates. These feature services are backed by an enterprise geodatabase (EGDB). The second feature is stream layers subscribing to stream services. In this second feature, web apps subscribe to immediately receive data. There is low latency and high throughput.

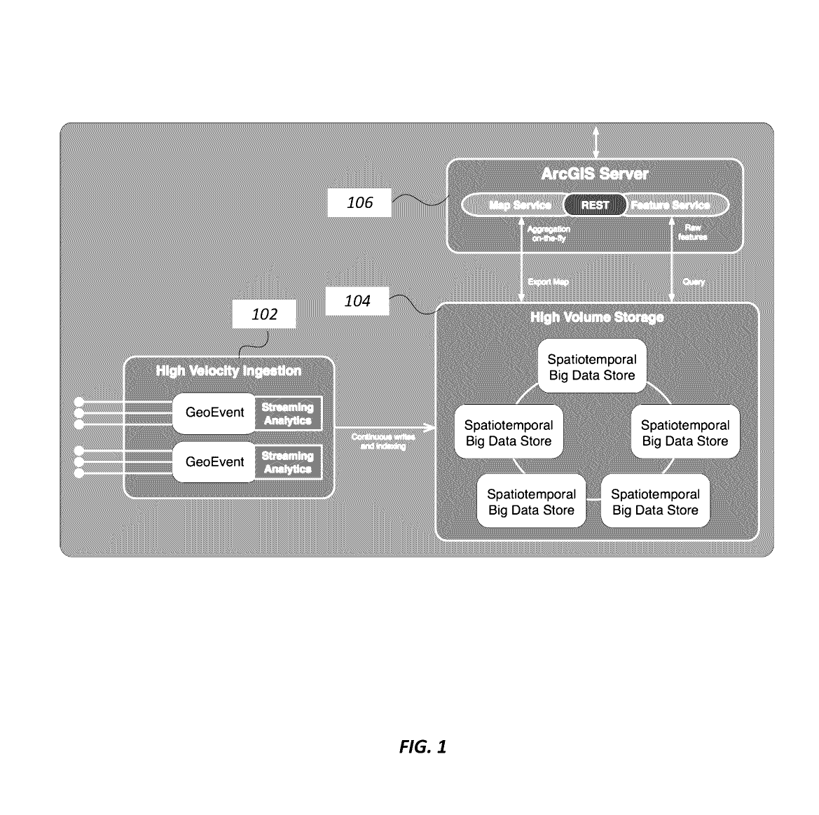

FIG. 1 illustrates a system with a high velocity ingestion module 102, a high volume spatiotemporal database 104 and a mapping server (ArcGIS) 106. In one embodiment, high velocity ingestion module 102 uses Apache Kafka and Spark streaming, a cluster computing system. Spatiotemporal database 104 is a distributed database that runs across many machines and has the ability to index incoming data by space and time. The database organization enables aggregations on the fly as users pan and zoom a map visualization. Below are components of one embodiment of the invention:

1. High Velocity and Volume ingestion of real-time spatiotemporal date (Kafka and Spark Streaming) (HVV-I)

HVV-I handles use cases such as Internet-of-Things (IoT), which include increasing single-nod throughput from thousands to tens of thousands of events per second, achieving near-linear scalability of throughput when adding additional machines, and gracefully handling bursty data via backpressure/buffering (preventing data loss)

### 2. High Velocity and Volume Spatiotemporal Storage/Archival (Spark and Elasticsearch)

ArcGIS 10.4 Spatiotemporal Big Data Store establishes a high velocity and volume ArcGIS Data Store that can be installed by an administrator, achieve growth in volume capacity and write throughput when adding additional machines, and efficiently access and query a large volume of data via a Feature Service or Map Service.

### 3. High Velocity and Volume Spatiotemporal Visualization (Elasticsearch Geohash)

ArcGIS 10.4 Spatiotemporal Big Data Store enables visualization of high velocity and volume data. This product comes with a map service that has the ability to do aggregation-on-the-fly by calculating at various levels of detail. In addition, when zoomed in far enough raw features are returned and rendered.

### 4. High Velocity and Volume Spatiotemporal Continuous, Batch, and Interactive Analytics (Spark+Elasticsearch)

ArcGIS 10.4 GeoEvent Extension for Server run continuous analytics on high velocity spatiotemporal data-in-motion by performing continuous spatial and/or temporal analytics while maintaining high throughput and introducing temporal analytic processing capabilities (Aggregator, Sliding Time Window).

In one example, noise sensors surround an airport, and report noise levels continuously. The Geoevent processor allows visualizing this using the operations dashboard for ArcGIS. It monitors, tracks, and reports events to users within an organization. Geoevent Processor is connecting these sensors to GIS features so that we can visualize their latest status. It is also performing continuous analysis on the noise reports as they're received.

With the ArcGIS spatiotemporal database, the following actions are possible:

Publish large numbers of hosted feature layers. If you plan to support publishing large numbers (thousands) of feature layers to your portal, it is strongly recommended that you use ArcGIS Data Store to create a relational data store. Hosted feature layers that rely on the relational data store require a smaller memory footprint to run, making it possible for you to publish many services with less hardware resources.

Publish Hosted Scene Layers to your Portal.

If your portal's hosting server is registered with ArcGIS Data Store, you can publish multipatch data as hosted scene layers from ArcGIS Pro 1.1 or later releases. You can publish 3D points as hosted scene layers from ArcGIS Pro 1.2 or later releases. The caches created for hosted scene layers are stored in a separate database in ArcGIS

Archive High Volume, Real-Time Observation Data.

If you use ArcGIS GeoEvent Extension to stream high volumes of live data, you can create a spatiotemporal big data store using the configuredatastore utility, and use it to store observation data.

### Create Backups of Hosted Feature Layer Data Automatically.

Backups ensure you can recover your feature data in the event of a disaster such as data corruption or hardware failure. You can control when and where automatic backups of the relational data store are created.

Configure a Failover Data Store for your Feature Layer Data and Scene Caches.

ArcGIS Data Store allows you to set up two data store machines. Your hosted feature layer and hosted scene layer tile cache data is replicated from one (the primary) to the other (the standby), so if the primary machine crashes, the standby machine can take its place with minimum downtime.

### Perform Analysis in the Portal for ArcGIS Map Viewer.

Your portal's hosting server must use an ArcGIS Data Store relational data store to enable analysis functionality in your portal.

In one embodiment, by way of example, you're in control of the logic, and your logic is captured on a service, which you author using a designer tool similar to a model builder. The real time data displayed can show violations in red appearing. These can be seen on the map as they're occurring, in real-time, as well as down below in a violation panel. Individuals could be sensors, using their smart phones. A sensor can be added to the dashboard, a user's phone. There is an application running on this phone, that's giving real-time data about what's coming through. The application can pick up surrounding noise, including the user's voice. That will be displayed on a map as well as in a gauge. So if there is a loud noise in a city or an aircraft taking off or gunfire or some other kind of loud noise, it will be detected in real time as a violation on the phone. Not only did we detect what was occurring, we detected where it was occurring and how long it occurred.

In another embodiment, for example, vehicles can be tracked. At Sea World there's over four million visitors that come. Oftentimes, there's VIPs or very important people that come to Sea World, and the staff wants to be notified whenever they're approaching the facility. So, using the geoevent processor, we can create a geofence on the fly, and use a three-minute drive time analysis layer as the basis of the geofence. The outer edge of the geofence area represents exactly three minutes away from the facility. Thus a user on the staff at Sea World can get alerted whenever a VIP vehicle comes in that proximity. Other vehicles will not generate an alert. As soon as the vehicle crossed the boundary, the Geoevent Processor actually sent off a text message to the staff person's phone as well, so Geoevent Processor isn't limited to alerting you through features on the display—it can also alert through e-mail, through text messages, through instant messages, or many other mediums as well.

This real-time GIS doesn't just apply to planes and vehicles, it can apply to just about anything, such as pipelines, oil wells, or utility networks like electric and gas. In one example, GIS provides views of real-time utility network usage. It can show the power generation and consumption levels at a site.

### Sample Embodiments of System Architectures

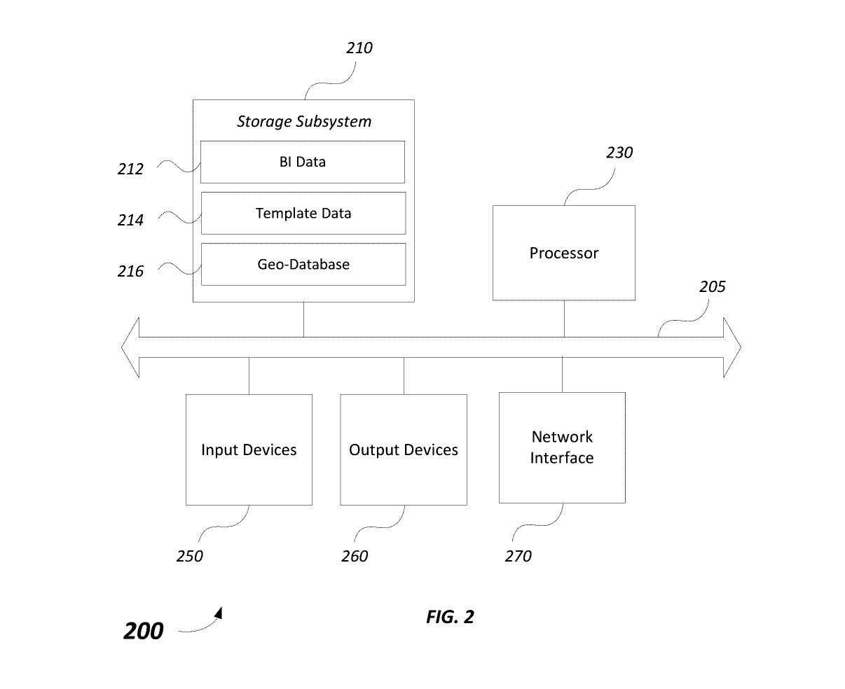

FIG. 2 illustrates a computer system 200 for performing semantic modeling of geographic information in business intelligence, according to certain embodiments of the invention. The processing, algorithms, and methods described herein (e.g., FIG. 1) can be implemented within a computer system (or a plurality of computer systems) such as computer system 200 shown here. Computer system 200 can be implemented as any of various computing devices, including, e.g., server(s), a desktop or laptop computer, tablet computer, smart phone, personal digital assistant (PDA), or any other type of computing device, not limited to any particular form factor. Computer system 200 can include processing unit(s) 230, storage subsystem 210, input devices 250 (e.g., keyboards, mice, touchscreens, etc.), output devices 260 (e.g., displays, speakers, tactile output devices, etc.), network interface 270 (e.g., RF, 4G, EDGE, WiFi, GPS, Ethernet, etc.), and bus 205 to communicatively couple the various elements of system 700 to one another.

Processing unit(s) 230 can include a single processor, multi-core processor, or multiple processors and may execute instructions in hardware, firmware, or software, such as instructions stored in storage subsystem 210. The storage subsystem 210 can include various memory units such as a system memory, a read only memory (ROM), and permanent storage device(s) (e.g., magnetic, solid state, or optical media, flash memory, etc.). The ROM can store static data and instructions required by processing unit(s) 230 and other modules of the system 200. The system memory can store some or all of the instructions and data that the processor needs at runtime.

In some embodiments, storage subsystem 210 can store one or more of data or software programs to be executed or controlled by processing unit(s) 230, such as BI data 212, Template Data 214, or Geo-Database Data 216. Other storage subsystems can be used, combined, or the like. As mentioned, “software” can refer to sequences of instructions that, when executed by processing unit(s) 230, cause computer system 200 to perform certain operations of the software programs. The instructions can be stored as firmware residing in read only memory and/or applications stored in media storage that can be read into memory for processing by processing unit(s) 230. Software can be implemented as a single program or a collection of separate programs and can be stored in non-volatile storage and copied in whole or in part to volatile working memory during program execution. From storage subsystem 210, processing unit(s) 230 can retrieve program instructions to execute in order to execute various operations (e.g., interpolations) described herein.

It will be appreciated that computer system 200 is illustrative and that variations and modifications are possible. Computer system 200 can have other capabilities not specifically described here in detail (e.g., GIS/BI technologies). Further, while computer system 200 is described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

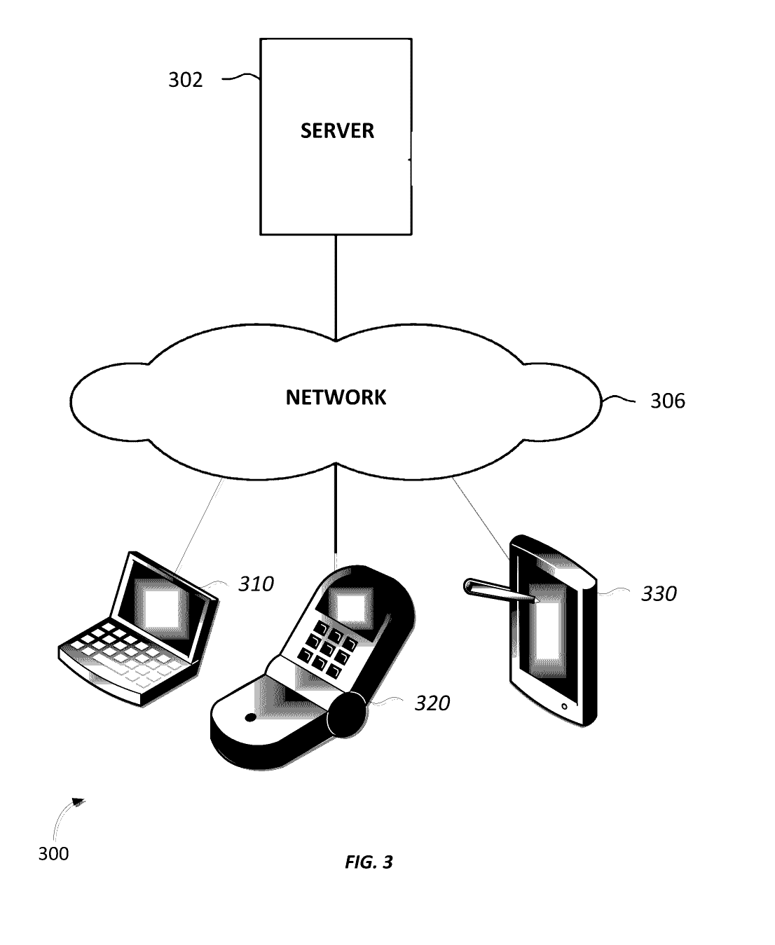

Aspects of system 200 may be implemented in many different configurations. In some embodiments, system 200 may be configured as a distributed system where one or more components of system 200 are distributed over one or more networks in the cloud. FIG. 3 depicts a simplified diagram of a distributed system 300 for providing a system and method for performing semantic modeling of geographic information in business intelligence, according to an embodiment of the invention. In the embodiment depicted in FIG. 3, system 300 is provided on a server 302 that is communicatively coupled with one or more remote client devices 310, 320, 330 via network 306.

Network 306 may include one or more communication networks, which could be the Internet, a local area network (LAN), a wide area network (WAN), a wireless or wired network, an Intranet, a private network, a public network, a switched network, or any other suitable communication network or combination thereof. Network 306 may include many interconnected systems and communication links including but not restricted to hardwire links, optical links, satellite or other wireless communications links, wave propagation links, or any communication protocol. Various communication protocols may be used to facilitate communication of information via network 306, including but not restricted to TCP/IP, HTTP protocols, extensible markup language (XML), wireless application protocol (WAP), protocols under development by industry standard organizations, vendor-specific protocols, customized protocols, and others as would be appreciated by one of ordinary skill in the art. In the configuration depicted in FIG. 3, aspects of system 300 may be displayed on any of client devices 310, 320, 330.

In the configuration depicted in FIG. 3, system 300 is remotely located from client devices 310, 320, 330. In some embodiments, server 302 may perform the methods of determining (or interpolating) a population over a geographic area described herein. In some embodiments, the services provided by server 302 may be offered as web-based or cloud services or under a Software as a Service (SaaS) model, as would be appreciated by one of ordinary skill in the art.

The various methods and embodiments described herein (e.g., the embodiments shown in FIG. 1) can be implemented in a system architecture, including aspects of those shown in FIGS. 2-3. The various methods and embodiments described above can be a computer-program product tangibly embodied in a non-transitory computer-readable storage medium, including instructions configured to cause a data processing system to perform said methods and embodiments. Any combination of the various embodiments described throughout this document are possible, as would be appreciated by one of ordinary skill in the art with the benefit of this disclosure.

While the invention has been described with respect to specific embodiments, one of ordinary skill in the art will recognize that numerous modifications are possible. Thus, although the invention has been described with respect to specific embodiments, it will be appreciated that the invention is intended to cover all modifications and equivalents within the scope of the following claims.

The above disclosure provides examples and aspects relating to various embodiments within the scope of claims, appended hereto or later added in accordance with applicable law. However, these examples are not limiting as to how any disclosed aspect may be implemented.

All the features disclosed in this specification (including any accompanying claims, abstract, and drawings) can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, sixth paragraph. In particular, the use of “step of” in the claims herein is not intended to invoke the provisions of 35 U.S.C. §112, sixth paragraph.

What is claimed is:

1. A mapping method executed on a processor comprising:
ingestion of real-time spatiotemporal data through an ingestion module, the ingestion module including real-time analysis of data-in-motion;
retrieving from a memory and presenting on a display, using the processor, a visualization of data that are calculated at various levels of detail and are specific to each user session; and
storage of high velocity and volume spatiotemporal data in a spatiotemporal database.

2. The method of claim 1 wherein the spatiotemporal database is a distributed database across a plurality of computers that indexes incoming data by space and time.

3. The method of claim 1 wherein the ingestion module comprises a cluster computing system.

4. The method of claim 1 wherein the method is optimized for use with web applications by providing stream services.
